(19) United States
(12) Patent Application Publication
(10) Pub. No.: US 2026/0177455 A1
(43) Pub. Date: Jun. 25, 2026

(54) EQUIPMENT-ANOMALY DETECTION SYSTEM AND METHOD

(71) Applicant: INDUSTRIAL TECHNOLOGY RESEARCH INSTITUTE, Hsinchu (TW)

(72) Inventors: Jih-Chieh LEE, Taipei City (TW); Wei-Xiang LIN, Changhua City (TW); Min-Rong CHEN, Huatan Township (TW); Meng-Chiu LIN, Taichung City (TW); Chun-Min CHANG, Taichung City (TW)

(73) Assignee: INDUSTRIAL TECHNOLOGY RESEARCH INSTITUTE, Hsinchu (TW)

(21) Appl. No.: 18/999,630

(22) Filed: Dec. 23, 2024

(51) Int. Cl. G01M 13/04; G05B 23/02; G06T 7/00

(52) U.S. Cl. CPC G01M 13/04; G05B 23/0281; G06T 7/001; G06T 2207/20084

(57) ABSTRACT

An equipment-anomaly detection method is provided. The equipment-anomaly detection method is executed by a computer system and includes obtaining a test signal from test equipment, and converting the test signal into a test-signal image. The equipment-anomaly detection method further includes applying a first classification model to determine whether the test equipment is normal or abnormal based on the test-signal image, and applying a second classification model to determine an anomaly class for the test equipment. The first classification model is a one-class classifier trained using multiple normal-signal images. The second classification model is trained using the normal-signal images, multiple abnormal-signal images, and multiple simulated abnormal-signal images. The simulated abnormal-signal images are generated by a generative model based on the normal-signal images and the abnormal-signal images.

### TECHNICAL FIELD

The present disclosure relates to an equipment-anomaly detection system and method which use generative artificial intelligence (AI).

### BACKGROUND

The term equipment anomaly refers to the unexpected or unconventional behavior of equipment that occurs during normal operation. Usually, equipment anomalies include reduced operating efficiency, unstable performance, and malfunctions. These may be caused for a variety of reasons, such as hardware failure, insufficient maintenance, improper operation, or changes in the external environment. The occurrence of an equipment anomaly may have a serious impact on the production process, including production stagnation, equipment damage, and even accidents. Therefore, timely identification, processing and even prevention of equipment anomalies are crucial to ensuring stable equipment operation and production safety.

Equipment anomalies are usually accompanied by irregular signal fluctuations, operating parameters that are too high or too low, increased noise, or abnormal vibrations, etc. By monitoring and analyzing the above-mentioned abnormal performance of the equipment, equipment anomalies can be predicted and prevented in advance, so that high production efficiency and long-term stability of the equipment can be ensured.

With the development of AI technology, equipment-anomaly detection technology has also been improved. However, existing AI equipment-anomaly detection technologies still face many challenges in practical applications. Since equipment anomalies naturally occur less frequently, it is quite difficult to collect sufficient anomaly data. Even if it is possible to make up for a lack of anomaly data by artificially creating anomalies, the cost is very high. In addition, the anomaly data that is generated may not necessarily match the actual anomalous conditions that may be encountered during actual use. Therefore, the accuracy of existing AI equipment-anomaly detection technology is still unable to reliably meet industry needs.

Therefore, an equipment-anomaly detection system and method that can solve the above problems are needed.

### SUMMARY

An embodiment of the present disclosure provides an equipment-anomaly detection system including a storage unit and a processing unit coupled to the storage unit. The storage unit is configured to store a first classification model and a second classification model. The processing unit is configured to obtain a test signal of a test equipment, and convert the test signal into a test-signal image. The processing unit is configured to use the first classification model to determine whether the test equipment is normal or abnormal based on the test-signal image. In response to the test equipment being abnormal, the processing unit is configured to use the second classification model to determine an anomaly class of the test equipment based on the test-signal image. The first classification model is a one-class classifier trained using multiple normal-signal images. The second classification model is trained using the normal-signal images, multiple abnormal-signal images, and multiple simulated abnormal-signal images. The simulated abnormal-signal images are generated by a generative model based on the normal-signal images and the abnormal-signal images.

An embodiment of the present disclosure provides an equipment-anomaly detection method. The equipment-anomaly detection method is executed by a computer system and includes obtaining a test signal from a test equipment, and convert the test signal into a test-signal image. The equipment-anomaly detection method further includes applying a first classification model to determine whether the test equipment is normal or abnormal based on the test-signal image, and applying a second classification model to determine an anomaly class for the test equipment. The first classification model is a one-class classifier trained using multiple normal-signal images. The second classification model is trained using the normal-signal images, multiple abnormal-signal images, and multiple simulated abnormal-signal images. The simulated abnormal-signal images are generated by a generative model based on the normal-signal images and the abnormal-signal images.

The equipment-anomaly detection system and method provided by this disclosure apply an AI generative model and an AI classification model to detect equipment anomalies. More specifically, by using the AI generative model to generate more abnormal data based on existing abnormal data, the AI classification model can detect equipment anomalies more accurately, so that an equipment anomaly can be identified, processed and even prevented timely. In addition, by applying two-stage equipment-anomaly detection through dual AI classification models, the misjudgment rate of equipment-anomaly detection can be reduced further.

### BRIEF DESCRIPTION OF THE DRAWINGS

The present disclosure can be more fully understood by reading the subsequent detailed description and examples with references made to the accompanying drawings, wherein:

FIG. 1 is a system architecture diagram of an equipment-anomaly detection system according to an embodiment of the present disclosure;

FIG. 2 is a data flow diagram of an equipment-anomaly detection method according to an embodiment of the present disclosure;

FIG. 3 is a data flow diagram of an implementation of training stages of a first classification model and a second classification model shown in FIG. 2;

FIG. 4 is a schematic diagram of implementing step S202 of FIG. 2 according to an embodiment of the present disclosure; and

FIG. 5 is a schematic diagram of an implementation of the generative model of FIG. 3 according to an embodiment of the present disclosure.

### DETAILED DESCRIPTION

The following description is made for the purpose of illustrating the general principles of the disclosure and should not be taken in a limiting sense. The scope of the disclosure is best determined by reference to the appended claims.

In each of the below embodiments, the same or similar elements or components will be represented by the same reference numerals.

The serial numbers in this description and the scope of the patent application, such as “first”, “second”, etc., are only for convenience of explanation, and there is no sequential relationship between them.

The description of the embodiments of the device or system in this disclosure also applies to the embodiments of the method, and vice versa.

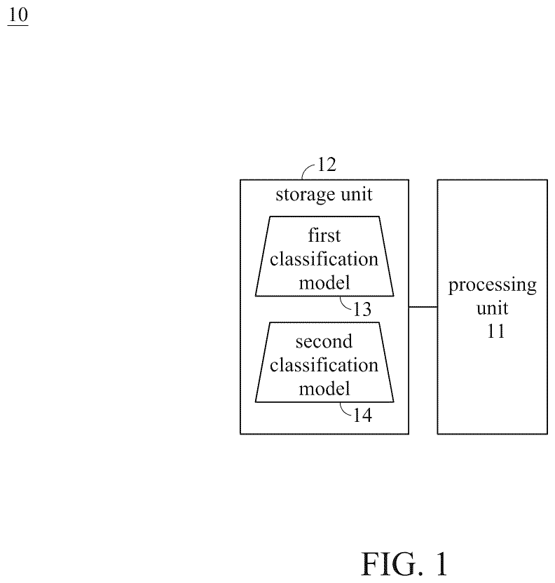

FIG. 1 is a system architecture diagram of an equipment-anomaly detection system 10 according to an embodiment of the present disclosure. As shown in FIG. 1, the equipment-anomaly detection system 10 includes a processing unit 11 and a storage unit 12. The processing unit 11 is coupled to the storage unit 12. The storage unit 12 stores a first classification model 13 and a second classification model 14.

The equipment-anomaly detection system 10 can be any computer with computing capabilities, such as a microcontroller, a personal computer (e.g., a desktop computer or a notebook computer), a server computer or a mobile device (e.g., a tablet computer or smart phone). It can also be a computer cluster composed of multiple computers working together. The disclosure is not limited thereto.

The processing unit 11 may include any one or more general-purpose or special-purpose processors and combinations thereof for executing instructions, e.g., a central processing unit (CPU) and/or a graphics processing unit (GPU). The processing unit 11 may also include volatile memories such as dynamic random access memory (DRAM) and/or static random access memory (SRAM). The disclosure is not limited thereto.

The storage unit 12 may include a hard disk (HDD), a solid state drive (SSD), an optical disk, or any other type of memory that contains non-volatile memory (e.g., read-only memory, electrically-erasable programmable read-only memory (EEPROM), flash memory, and non-volatile random access memory (NVRAM)). The disclosure is not limited thereto.

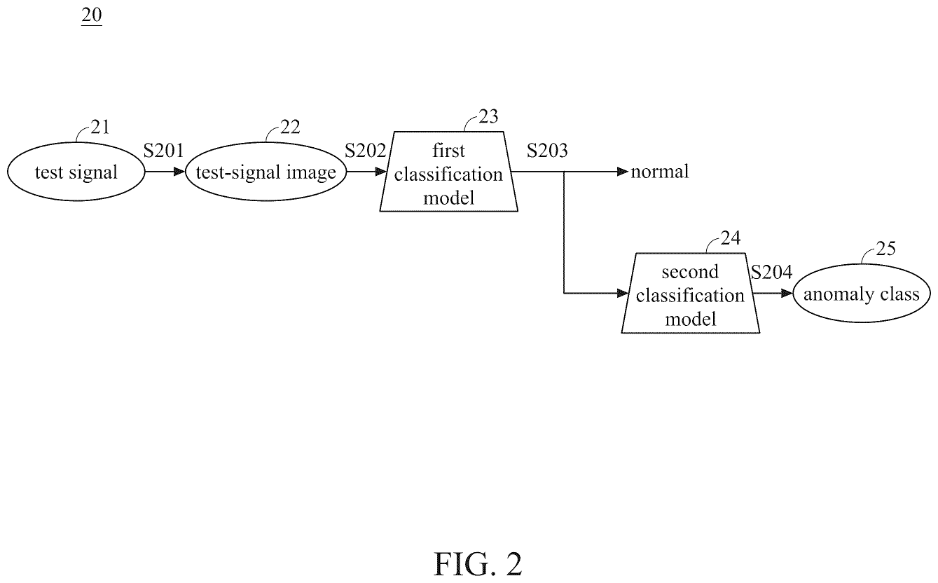

FIG. 2 is a data flow diagram of an equipment-anomaly detection method 20 according to an embodiment of the present disclosure. The equipment-anomaly detection method 20 is executed in the equipment-anomaly detection system 10. As shown in FIG. 2, the equipment-anomaly detection method 20 includes steps S201 to S204.

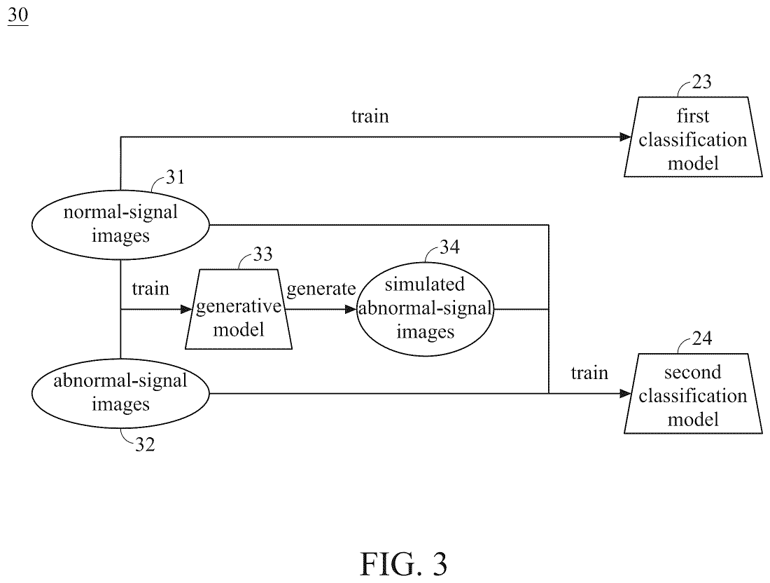

Correspondingly, FIG. 3 is a data flow diagram of an implementation of training stages of a first classification model 23 and a second classification model 24 shown in FIG. 2 in this embodiment. In the following, steps S201 to S204 will be described with reference to FIG. 2 and FIG. 3.

In step S201, the processing unit 11 obtains a test signal 21 from a test device, and converts the test signal 21 into a test-signal image 22.

In one embodiment, the test signal 21 may be a vibration signal generated by a mechanical device (e.g., a motor, gear, pump, fan, etc.) during operation, which may be obtained through an accelerometer or vibration sensor, for example. In another embodiment, the test signal 21 can be an audio signal generated when the device is running, which can be obtained through a microphone, for example. In other embodiments, the test signal 21 may be a current signal, and a voltage signal, a temperature signal, a pressure signal, a displacement signal or a rotational speed signal, etc. The disclosure is not limited thereto.

In one embodiment, the processing unit 11 also performs a short-time Fourier transform (STFT) on the test signal 21 to convert the test signal 21 into a test-signal image 22. In this embodiment, the test-signal image 22 may be a spectrogram, with the X-axis representing time, the Y-axis representing frequency, and the color or gray scale representing the signal strength within a specific time and frequency range.

In step S202, the processing unit 11 uses the first classification model 23 to determine whether the test equipment is normal or abnormal based on the test-signal image 22.

When the data amount of normal-signal images and abnormal-signal images is sufficient, the first classification model 23 can use labeled normal-signal images and labeled abnormal-signal images to do supervised learning in the training stage. In this case, the first classification model 23 may be a binary classifier implemented using a convolutional neural network (CNN), a support vector machine (SVM), a decision tree, or an autoencoder (AE). The disclosure is not limited thereto.

However, as mentioned previously, the data amount of the abnormal-signal images is insufficient in practice. This leads to the supervised learning method unable to meet the needs of industrial applications. In response, as shown in FIG. 3, the first classification model 23 is a one-class classifier trained using a plurality of normal-signal images 31 of the test equipment. That is, the first classification model 23 only uses normal-signal images to do unsupervised learning in the training stage, without using abnormal-signal images. The first classification model 23 can be implemented using a one-class SVM, an isolation forest, or an autoencoder. The disclosure is not limited thereto.

Notably, as the first classification model 23 is a binary classifier, using only the normal-signal images 31 to train the first classification model 23 will not reduce the performance of the first classification model 23. Instead, the first classification model 23 may learn the pattern or structure of the normal-signal image. This may enhance the ability of the first classification model 23 to identify the normal-signal image. In addition, this may also reduce labeling costs and solve the aforementioned problem of inefficiently learning caused by insufficient abnormal-signal images.

In step 203 and step 204, in response to determining that the test equipment is abnormal, the processing unit 11 uses the second classification model 24 to determine an anomaly class 25 for the test equipment based on the test-signal image 22.

In one embodiment, the anomaly class 25 may be a damage state related to the rolling bearing such as ball damage, inner ring damage, outer ring damage, etc. In other embodiments, corresponding to the type of the test signal 21 (e.g., current and voltage signals, rotational speed signals, etc.), the anomaly class 25 may include, for example, overcurrent, voltage fluctuation, fan blade imbalance, etc. The disclosure is not limited thereto.

In one embodiment, the second classification model 24 is implemented using a convolutional neural network (CNN). In other embodiments, the second classification model 24 may be implemented using a support vector machine (SVM), a decision tree, a K-Nearest Neighbors algorithm (KNN), other neural networks, etc. The disclosure is not limited thereto.

When the data amount of abnormal-signal images 32 is sufficient, the second classification model 24 may directly do supervised learning using the labeled normal-signal images 31 and the labeled abnormal-signal images 32 in the training stage.

However, as mentioned previously, the data amount of the abnormal-signal images is insufficient in practice. In response, as shown in FIG. 3, in addition to the normal-signal images 31 and the abnormal-signal images 32, the second classification model 24 is also trained using a plurality of simulated abnormal-signal images 34. The simulated abnormal-signal image 34 is generated based on the normal-signal images 31 and the abnormal-signal images 32 using a generative model 33.

Specifically, the generative model 33 may use a generative adversarial network (GAN), a variational autoencoder (VAE), an autoregressive model, etc. The disclosure is not limited thereto.

Notably, as the second classification model 24 is a multiclass classifier, the generative model 33 is applied to generate the simulated abnormal-signal image 34. That is, more abnormal-signal images are generated. This may prevent the second classification model from bad anomaly-class classifying ability caused by the insufficient data amount of the abnormal-signal images 32.

Additionally, although the first classification model 23, the second classification model 24 and the generative model 33 reuse the normal-signal image 31 and the abnormal-signal image 32 in FIG. 3, the disclosure does not require them of using the same data set. As long as the type of the signal image is consistent with that of the test signal 21 (e.g., vibration signal), the first classification model 23, the second classification model 24 and the generation model 33 may use different normal-signal images and abnormal-signal images for training.

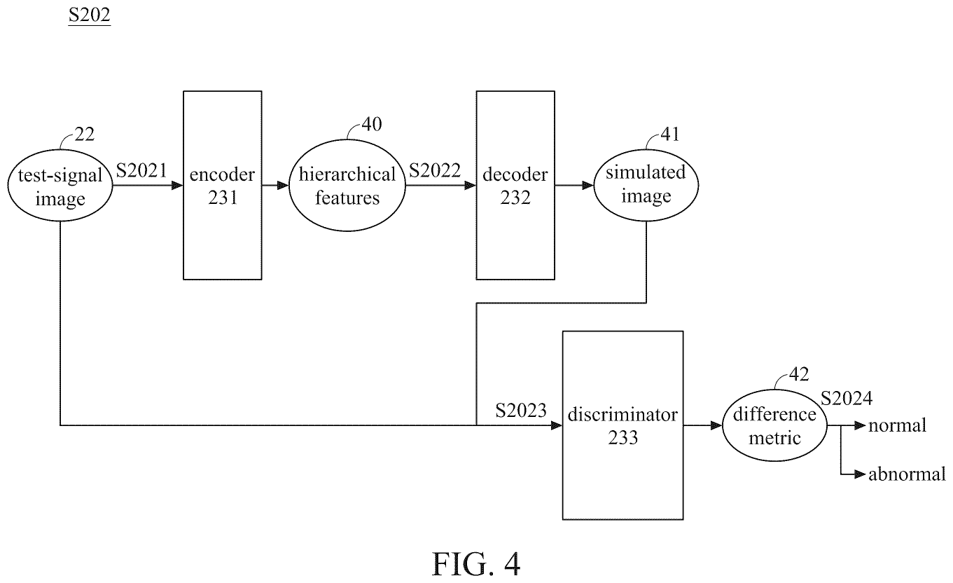

FIG. 4 is a schematic diagram of implementing step S202 of FIG. 2 according to an embodiment of the present disclosure. The first classification model 23 includes an encoder 231, a decoder 232 and a discriminator 233. As shown in FIG. 4, step S202 includes steps S2021˜S2024.

In step S2021, the encoder 231 extracts hierarchical features 40 of the test-signal image 22.

Specifically, the encoder 231 is composed of multiple layers of neural networks, including, for example, fully connected layers, convolutional layers, etc. Optionally, the encoder 231 may also include a pooling layer, so as to keep key features while reducing dimensionality and to enhance the translation invariance. Through a series of convolutional layers and pooling layers, the encoder can convert high-dimensional data into a low-dimensional latent space representation.

Hierarchical features 40 refer to multi-level feature representations that are extracted step by step during the processing of the encoder 231, including low-level local features (e.g., edge, texture) to high-level abstract features (e.g., shape or structure). In addition, the encoder 231 also transmits the hierarchical features 40 to the decoder 232 through skip connections, so as to effectively keep detailed information of each level of the test-signal image 22 and to avoid information loss caused by multiple dimensionality reductions.

In step S2022, the decoder 232 reconstructs a simulated image 41 corresponding to the test-signal image based on the hierarchical features 40.

Specifically, the decoder 232 is also composed of multiple layers of neural networks, including, for example, a fully connected layer, a transposed convolutional layer, etc. In addition to the latent space representation output by the encoder 231 at the input layer, the decoder 232 also receives the hierarchical features 40 from the corresponding layer using the skip connection, so as to reconstruct the simulated image 41.

Keeping the features extracted from different layers in the hierarchical features 40 can avoid losing too much detailed information during forward propagation in the deep neural network of the encoder 231. This helps the decoder 232 reconstruct the simulated image 41 corresponding to the test-signal image 22.

In step S2023, the discriminator 233 calculates a difference metric 42 between the simulated image 41 and the test-signal image 22. In step S2024, the processing unit 11 determines whether the test equipment is normal or abnormal based on the difference metric 42.

Specifically, the discriminator 233 is based on a convolutional neural network. The discriminator 233 receives real images and generated images, and outputs a probability value between 0 and 1. When the value is close to 1, it means that the discriminator misjudged the generated image as real (true). When the value is close to 0, it means that the discriminator judges the generated image as fake (false).

In one embodiment, the discriminator 233 is a modification of the above discriminator. The discriminator 233 receives the simulated image 41 and the test-signal image 22, and outputs a probability value between 0 and 1. However, the difference is that when the value is close to 1, it means that the discriminator 233 determines that the test-signal image 22 is normal. When the value is close to 0, it means that the discriminator 233 determines that the test-signal image 22 is abnormal.

Specifically, the discriminator 233 calculates the distance (i.e., the difference) between the simulated image 41 and the test-signal image 22, so as to obtain the difference metric 42.

In one embodiment, the discriminator 233 calculates the pixel-level distance between the two. That is, the discriminator 233 calculates the difference between each pixel of the simulated image 41 and the corresponding pixel of the test-signal image 22. In one embodiment, the discriminator 233 calculates the feature-level distance between the two. Specifically, the discriminator 233 generates individual feature values based on the simulated image 41 and the test-signal image 22, and calculates the difference between the two feature values. In one embodiment, the discriminator 233 calculates the pixel-level distance and the feature-level distance between the two, and performs a weighted sum of the calculation results. The above calculation of the discriminator 233 can be based on, for example, mean-square error (MSE), L2 distance, etc. The disclosure is not limited thereto.

In one embodiment, the discriminator 233 outputs the distance between the simulated image 41 and the test-signal image 22 as the difference metric 42. In one embodiment, the discriminator 233 also performs feature scaling on the distance between the simulated image 41 and the test-signal image 22, so as to convert the distance into a probability value between 0 and 1. Then, the discriminator 233 use the probability value as difference metric 42. The feature scaling method adopted by the discriminator 233 may be, for example, min-max scaling.

Next, the processing unit 11 determines whether the device under test is normal or abnormal based on the difference metric 42 and a threshold. It should be noted that the threshold is not a fixed value and can be adjusted according to application requirements. Generally, the choice of threshold is based on the distribution of training data. For example, the threshold can be set based on the distribution of difference metrics of normal-signal images. Alternatively, the threshold can be set by calculating statistical indicators (e.g., mean and standard deviation) for the difference indicators of normal-signal images.

FIG. 4 only describes the steps of the first classification model 23 in the inference stage. The steps of the first classification model 23 in the training stage are described further in the following paragraphs.

The following steps are executed for each normal-signal image. First, the encoder 231 extracts the hierarchical feature of the normal-signal image. Next, the decoder 232 reconstructs a simulated normal-signal image corresponding to the normal-signal image based on the hierarchical feature. Then, the discriminator 233 calculates the difference metric based on the simulated normal-signal image and the normal-signal image. Finally, the processing unit 11 determines whether the test equipment is normal or abnormal based on the difference metric. Furthermore, the processing unit 11 calculates training loss based on the determination, the normal-signal image, and the simulated normal-signal image. Furthermore, the processing unit 11 updates the parameters of the decoder 231, the decoder 232 and the discriminator 233 based on the training loss.

In one embodiment, the training loss can be a weighted summation of the pixel-level distance between the simulated normal-signal image and the normal-signal image, the feature-level distance between the simulated normal-signal image and the normal-signal image, the performance of the encoder 231 the decoder 232 (collectively called a generator) and the performance of the discriminator 233.

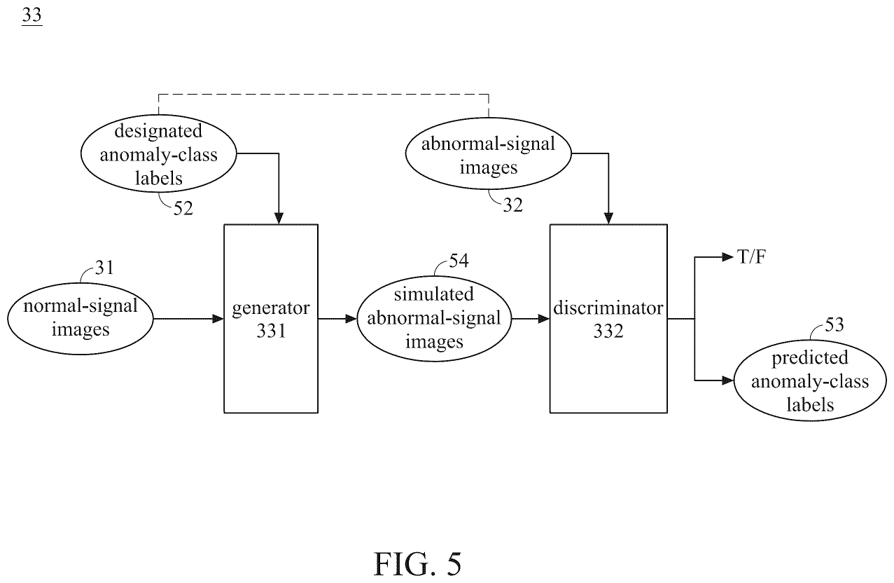

FIG. 5 is a schematic diagram of an implementation of the generative model 33 of FIG. 3 according to an embodiment of the present disclosure. The generative model 33 includes a generator 331 and a discriminator 332.

The generator 331 is used for generating simulated abnormal-signal images 54 based on the normal-signal images 31 and a plurality of designated anomaly-class labels 52. The anomaly class indicated by the designated anomaly-class label 52 should be one of the possible anomaly classes 25. In one embodiment, the anomaly class 25 is one of ball damage, inner ring damage, and outer ring damage. Accordingly, the designated anomaly-class label 52 should be assigned to one of ball damage, inner ring damage, and outer ring damage.

In one embodiment, the generator 331 can be considered to be a convolutional neural network (CNN), including a fully connected layer, a convolution layer, a transposed convolution layer, etc. The disclosure is not limited thereto.

Notably, the generator 331 generates the simulated abnormal-signal image 54 based on “the normal-signal image 31”. Compared with random noise, the data distribution of the normal-signal image 31 will be closer to that of a signal image. Therefore, compared with using random noise as input, using normal-signal images 31 as input helps the generator 331 learn to generate simulated abnormal-signal images faster during the training stage.

The discriminator 332 is used for identifying the authenticity (True/False; T/F) of the simulated abnormal-signal image 54 based on the abnormal signal-image 32 corresponding to the designated anomaly-class label 52. In other words, the discriminator 332 can identify whether the simulated abnormal-signal image 54 is a real image.

In one embodiment, the discriminator 332 may be implemented using a convolutional neural network (CNN).

In one embodiment, the discriminator 332 outputs a probability value between 0 and 1 based on the abnormal signal-image 32 and the simulated abnormal-signal image 54. Then, the processing unit 11 can also determine the authenticity of the simulated abnormal-signal image 54 based on this probability value. When the probability value is close to 1, it means that the discriminator 332 determines that the simulated abnormal-signal image 54 is real (true). When the probability value is close to 0, it means that the discriminator 332 determines that the simulated abnormal-signal image 54 is fake (false).

In addition, the discriminator 332 is also configured to generate predicted anomaly-class labels 53 associated with each of the simulated abnormal-signal images 54. In other words, the discriminator 332 can also determine the anomaly class of the simulated abnormal-signal image 54.

The anomaly class in the predicted anomaly-class label 53 should also be one of the possible anomaly classes 25. In one embodiment, the anomaly class 25 is one of ball damage, inner ring damage, and outer ring damage. Correspondingly, the designated anomaly-class label 52 is one of ball damage, inner ring damage, and outer ring damage.

In one embodiment, the discriminator 332 also outputs a probability vector based on the abnormal-signal image 32 and the simulated abnormal-signal image 54. This probability vector contains a plurality of probability values between 0 and 1. Each probability value represents the probability that the simulated abnormal-signal image 54 belongs to the corresponding class. Then, the processing unit 11 can also determine the class of the simulated abnormal-signal image 54 based on the probability vector.

In one embodiment, the processing unit 11 also calculates training loss during the training stage of the generative model 33, and adjusts the parameters of the generator 331 and the discriminator 332 according to the training loss. Specifically, the training loss includes a loss of the generator 331 and a loss of the discriminator 332. The loss of the discriminator 332 is used for maximizing the ability of the discriminator 332 to do classification and to distinguish between true and false. The loss of the generator 331 is used for maximizing the ability of the discriminator 332 to do classification and for minimizing the ability of the discriminator 332 to distinguish between true and false. The parameters can be updated using gradient descent algorithm or its variants, e.g., adaptive moment estimation (Adam) or RMSProp. The disclosure is not limited thereto.

In one embodiment, the processing unit 11 uses the trained generator 331 to generate the simulated abnormal-signal image 54 as the simulated abnormal-signal image 34 for training the second classification model 24. In one embodiment, the processing unit 11 keeps the simulated abnormal-signal images that are determined to be true and correctly classified by the discriminator 332 as the simulated abnormal-signal images 34 during the training stage of the generative model 33. In this way, the efficiency of collecting training data for the second classification model 24 can be improved.

It should be noted that the first classification model 23, the second classification model 24 and the generative model 33 are deployed on the same device. However, the disclosure is not limited thereto. In some embodiments, the generative model 33 can be independently deployed on another device or another computer system (e.g., a cloud computing platform) to provide a training dataset for various anomaly classification models. In some embodiments, the first classification model 23, the second classification model 24 and the generation model 33 can be deployed on different devices. The disclosure is not limited thereto.

In an embodiment, the processing unit 11 may also take different actions based on the anomaly class 25. For example, the processing unit 11 may immediately shut down the test equipment, alert the equipment manager to replace parts, or immediately activate the backup device, etc. The disclosure is not limited thereto.

The equipment-anomaly detection system and method provided by this disclosure apply an AI generative model and an AI classification model to detect equipment anomalies. More specifically, by using the AI generative model to generate more abnormal data based on existing abnormal data, the AI classification model can detect equipment anomalies more accurately, so that each equipment anomaly can be identified, processed and even prevented timely. In addition, by applying two-stage equipment-anomaly detection through dual AI classification models, the misjudgment rate of equipment-anomaly detection can be reduced further.

The above paragraphs are described in various ways. Obviously, the teachings of this article can be implemented in a variety of ways, and any specific architecture or functionality disclosed in the examples is only a representative situation. Based on the teachings of this article, it should be understood in the art that each aspect disclosed in this article can be implemented independently, or two or more aspects can be combined and implemented.

Although the present disclosure has been described using embodiments as above, they are not intended to limit the present disclosure. A person skilled in the art may make some modifications without departing from the spirit and scope of the present disclosure. Therefore, the protection scope of the disclosure shall be determined by the appended patent application scope.

What is claimed is:

1. An equipment-anomaly detection system, comprising:
a storage unit, configured to store a first classification model and a second classification model; and
a processing unit, coupled to the storage unit, and configured to:
obtain a test signal of a test equipment, and convert the test signal into a test-signal image;
use the first classification model to determine whether the test equipment is normal or abnormal based on the test-signal image; and
in response to the test equipment being abnormal, use the second classification model to determine an anomaly class of the test equipment based on the test-signal image;
wherein the first classification model is a one-class classifier trained using a plurality of normal-signal images of the test equipment;
wherein the second classification model is trained using the normal-signal images, a plurality of abnormal-signal images and a plurality of simulated abnormal-signal images, wherein the simulated abnormal-signal images are generated by a generative model based on the normal-signal images and the abnormal-signal images.

2. The equipment-anomaly detection system as claimed in claim 1, wherein the generative model comprises:
a generator, used for generating the simulated abnormal-signal images based on the normal-signal images and a plurality of designated anomaly-class labels; and
a discriminator, used for determining authenticity of the simulated abnormal-signal images based on the abnormal-signal images which correspond to the designated anomaly-class labels, and used for generating a predicted anomaly-class label with which the simulated abnormal-signal images are respectively associated.

3. The equipment-anomaly detection system as claimed in claim 1, wherein the second classification model is implemented using a convolutional neuron network (CNN).

4. The equipment-anomaly detection system as claimed in claim 1, wherein the first classification model comprises:
an encoder, used for extracting hierarchical features of the test-signal image;
a decoder, used for reconstructing a simulated image corresponding to the test-signal image based on the hierarchical features; and
a discriminator, used for calculating a difference metric between the simulated image and the test-signal image;
wherein the processing unit is further configured to determine whether the test equipment is normal or abnormal based on the difference metric.

5. The equipment-anomaly detection system as claimed in claim 4, wherein in a training stage of the first classification model:
the encoder is configured to extract the hierarchical features of each of the normal-signal images;
based on the hierarchical features of each of the normal-signal images, the decoder is configured to reconstruct a simulated normal-signal image corresponding to the normal-signal image; and
the discriminator is configured to calculate the difference metric between the simulated normal-signal image and the normal-signal image;
wherein the processing unit is further configured to:
determine whether the test equipment is normal or abnormal based on the difference metric;
calculate training loss based on the determination, the normal-signal image and the simulated normal-signal image; and
update parameters of the encoder, the decoder and the discriminator based on the training loss.

6. The equipment-anomaly detection system as claimed in claim 1, wherein the processing unit is further configured to perform a short-time Fourier transform (STFT) on the test signal, so as to convert the test signal into the test-signal image.

7. The equipment-anomaly detection system as claimed in claim 1, wherein the anomaly class is one of ball damage, inner ring damage, and outer ring damage.

8. An equipment-anomaly detection method, executed by a computer system, and comprising:
obtaining a test signal of a test equipment, and converting the test signal into a test-signal image;
using a first classification model to determine whether the test equipment is normal or abnormal based on the test-signal image; and
in response to the test equipment being abnormal, using a second classification model to determine an anomaly class of the test equipment based on the test-signal image;
wherein the first classification model is a one-class classifier trained using a plurality of normal-signal images of the test equipment;
wherein the second classification model is trained using the normal-signal images, a plurality of abnormal-signal images and a plurality of simulated abnormal-signal images, wherein the simulated abnormal-signal images are generated by a generative model based on the normal-signal images and the abnormal-signal images.

9. The equipment-anomaly detection method as claimed in claim 8, wherein the generative model comprises:
a generator, used for generating the simulated abnormal-signal images based on the normal-signal images and a plurality of designated anomaly-class labels; and
a discriminator, used for determining authenticity of the simulated abnormal-signal images based on the abnormal-signal images which correspond to the designated anomaly-class labels, and used for generating a predicted anomaly-class label with which the simulated abnormal-signal images are respectively associated.

10. The equipment-anomaly detection method as claimed in claim 8, wherein the second classification model is implemented using a convolutional neuron network (CNN).

11. The equipment-anomaly detection method as claimed in claim 8, wherein the first classification model comprises:
an encoder, used for extracting hierarchical features of the test-signal image;
a decoder, used for reconstructing a simulated image corresponding to the test-signal image based on the hierarchical features; and
a discriminator, used for calculating a difference metric between the simulated image and the test-signal image;
wherein the equipment-anomaly detection method further comprises determining whether the test equipment is normal or abnormal based on the difference metric.

12. The equipment-anomaly detection method as claimed in claim 11, further comprising a training stage of the first classification model, wherein the training stage comprises:
using the encoder to extract the hierarchical features of each of the normal-signal images;
based on the hierarchical features of each of the normal-signal images, using the decoder to reconstruct a simulated normal-signal image corresponding to the normal-signal image;
using the discriminator to calculate the difference metric between the simulated normal-signal image and the normal-signal image;
determining whether the test equipment is normal or abnormal based on the difference metric;
calculating training loss based on the determination, the normal-signal image and the simulated normal-signal image; and
updating parameters of the encoder, the decoder and the discriminator based on the training loss.

13. The equipment-anomaly detection method as claimed in claim 8, further comprising performing a short-time Fourier transform (STFT) on the test signal, so as to convert the test signal into the test-signal image.

14. The equipment-anomaly detection method as claimed in claim 8, wherein the anomaly class is one of ball damage, inner ring damage, and outer ring damage.
